(19) United States
(12) Patent Application Publication
(10) Pub. No.: US 2013/0308736 A1
(43) Pub. Date: Nov. 21, 2013

(54) Porous Scaffolds for Hydrogen Fuel in Inertial Confinement Fusion Capsules

(71) Applicant: Lawrence Livermore National Security, LLC, (US)

(72) Inventor: Sergei O. Kucheyev, Oakland, CA (US)

(73) Assignee: Lawrence Livermore National Security, LLC, Livermore, CA (US)

(21) Appl. No.: 13/670,288

(22) Filed: Nov. 6, 2012

Related U.S. Application Data
(60) Provisional application No. 61/558,990, filed on Nov. 11, 2011.

(51) Int. Cl. G21B 1/19

(52) U.S. Cl. CPC G21B 1/19; B82Y 15/00
USPC 376/151; 264/5; 977/755; 977/882; 977/932

(57) ABSTRACT

A fusion fuel capsule is disclosed having a substantially spherical ablator shell. The interior surface of the shell is lined with a nanoporous scaffold layer wetted with either a fully or partially liquid mixture of deuterium and tritium.

### REFERENCE TO RELATED APPLICATION

This application claims priority from U.S. Provisional Patent Application entitled “Porous Scaffolds for Hydrogen Fuel Layering of Inertial Confinement Fusion Targets,” U.S. Application No. 61/558,990, filed Nov. 11, 2011, which is incorporated herein by reference in its entirety.

### STATEMENT AS TO RIGHTS TO INVENTIONS MADE UNDER FEDERALLY SPONSORED RESEARCH OR DEVELOPMENT

The United States Government has rights in this invention pursuant to Contract No. DE-AC52-07NA27344 between the United States Department of Energy and Lawrence Livermore National Security, LLC.

### BACKGROUND OF THE INVENTION

For many decades, thermonuclear fusion power, in either pure fusion or fission-fusion hybrid reactors, has been envisioned as a viable solution for future world's energy demands. In such reactors, energy is harvested from nuclear fusion reactions of light nuclei such as deuterium (D) and tritium (T) hydrogen isotopes. This invention relates to capsules containing hydrogen fuel for inertial confinement fusion (ICF) based power plants. Fuel targets for ICF have been discussed in detail in the literature. See, for example, Kucheyev and Hamza, Journal of Applied Physics, vol. 108, pp. 091101/1-28 (2010).

The National Ignition Facility (NIF) is a laser-based ICF research machine located at the Lawrence Livermore National Laboratory in Livermore (LLNL), Calif. Several ICF-based power plants have been proposed. The equipment, systems, and support necessary for the deployment of such a fusion power plant are now being investigated and designed at LLNL.

The ICF process typically involves a spherically symmetric implosion of a spherical capsule, with a diameter of about 1-2 mm, called a target, filled with the fusion fuel. The fuel is typically a DT mixture. The compression of the fuel is achieved by a rapid and violent ablation of the capsule outer surface so that the outer surface of the capsule vaporizes and expands, behaving as an ablation-driven rocket. Different so-called drivers can be used for capsule ablation, including high-power lasers, ion beams, and Z-pinch machines. The drivers can be classified into two main categories: direct drive and indirect drive. In indirect drive, the energy from lasers, ion beams, or x-rays from a Z-pinch machine is first absorbed in a high-Z enclosure, called a hohlraum, surrounding the fuel capsule. The resulting x-rays emitted by the hohlraum material drive the ablation-caused implosion of the capsule. An example of an indirect laser drive target with a cylindrical hohlraum (such as used at NIF) is shown in FIG. 1. While ion-beam and Z-pinch drivers operate only in the indirect drive mode, a laser could be used for either direct or indirect drive implosions. In direct drive, a hohlraum is not used, and laser light directly illuminates the capsule. In the NIF system, 192 laser beams focus energy on the interior surfaces of the hohlraum, causing the fuel capsule to ablate, heating and compressing the DT to the temperature and pressure required for a fusion reaction. The invention described here relates to ICF fuel capsules and is independent of the type of the driver.

The two implosion schemes relevant to this invention are schematically shown in FIGS. 2(a) and 2(b). These are the so called hot-spot ignition [FIG. 2(a)] and fast ignition [FIG. 2(b)] schemes. In the hot-spot design currently pursued at NIF at LLNL, the capsule has most of the fuel confined in a condensed phase in a layer on the inner surface of the ablator shell and a small amount of the fuel in the gas phase in the capsule interior. During the implosion, the fuel in the gas phase is compressed into the center of the capsule to target densities sufficient for ignition.

In the fast ignition scheme [FIG. 2(b)], the fuel is compressed as in the hot-spot target, but not to the point of ignition. Instead, ignition is achieved through the use of another short laser pulse at peak compression focused at the apex of a hollow metal cone. The short laser pulse generates an intense beam of fast electrons or protons that heat and ignite the fuel. Because the main compression does not lead to ignition, the symmetry requirements for fast-ignition targets are expected to be significantly relaxed compared to those for hot-spot ignition.

Independent of the driver type, all ICF schemes require a target with thermonuclear fuel. Most current hot-spot ignition target designs call for an about 100-micron-thick condensed layer of a mixture of D and T hydrogen isotopes inside an about 1000-micron-radius hollow spherical capsule. The hydrogen fuel mixture is in a condensed phase held at a temperature of less than about 20 K.

When the capsule is filled, under gravity, liquid hydrogen forms a puddle at the capsule bottom, as schematically illustrated in FIG. 3. On cooling below the triple point (for an isotopically pure fuel) or below the liquidus temperature (for a multicomponent hydrogen systems such as DT), a hydrogen melt normally crystallizes in the hexagonal closed packed (hcp) structure. Solidification of a liquid puddle at the capsule bottom in FIG. 3 is, in fact, a process of crystallization from a melt in a spherical “crucible.” When a DT filled capsule is in a spherically symmetric thermal environment, the beta decay of tritium is a source of volumetric heating in solid hydrogen, resulting in the formation of a radial thermal gradient. This leads to redistribution of solid hydrogen uniformly across the capsule wall via evaporation of warmer thicker regions and condensation onto thinner colder regions. This is the basis of the beta layering method currently used at NIF and reviewed in detail in the literature. A spherically symmetric thermal environment can be achieved by placing the capsule in the center of a hollow sphere, filled with helium heat exchange gas, of uniform temperature or inside a cylinder with two “shimming” heaters, one above and one below the capsule, as shown in FIGS. 1 and 3.

Experiments, however, have revealed that the ultimate roughness of the hydrogen solid/vapor interface is related to boundaries between crystallites, and a non-trivial steady-state topography of the interface typically develops. The roughness of the solid DT layers is a result of complex crystallization and polygonization processes and is caused by grain boundary grooves. Previous efforts to minimize roughness of solid hydrogen layers have, therefore, been focused on minimizing the effect of grain boundaries by forming single-crystalline hydrogen layers.

Therefore, best quality hydrogen layers reported are hcp single crystals grown from a melt in a setup with a fill tube with typical growth times of over 10 hours. Numerous challenges of this approach still remain, including control of crystal nucleation, growth instabilities, thermal grooving, fractionation, and mechanical deformation.

As presently contemplated, a megawatt size ICF power plant will require on the order of 10 targets per second. Thus, ICF target designers must consider many engineering requirements in addition to the physics requirements for a successful target implosion. These considerations include low target cost, high manufacturing throughput, and the ability of the target to survive the forces and temperatures of injection into the fusion chamber, yet arrive in a condition for implosion. It is challenging to scale the current layering approach pursued at NIF that involves single crystal DT growth to low costs and high manufacturing throughput needed for an ICF-based power plant.

The liquid hydrogen puddle, illustrated in FIG. 3, can be redistributed uniformly on the walls of a spherical capsule if the gravitational force causing sagging of the liquid is compensated by capillary forces of a spherically symmetrical low-density nanoporous scaffold liner. This was proposed in a theoretical paper of Sacks and Darling [Sacks and Darling, Nuclear Fusion, 27:3, 447 (1987)]. Because the DT fuel is kept in a liquid phase above its melting temperature, however, a limitation of this earlier approach is the presence of a large density of hydrogen vapor inside the capsule. For purposes of efficient fusion reactions this is highly undesirable. For example, indirect-drive central hot-spot ignition targets currently fielded at NIF call for a temperature of about 1.5 K below the melting temperature of DT.

### BRIEF SUMMARY OF THE INVENTION

In the present invention, a nanoporous scaffold is used for both (i) symmetrizing the hydrogen fuel inside the ICF capsule and (ii) suppressing the crystallization temperature of liquid hydrogen, lowering the vapor pressure of hydrogen in the capsule gas-phase cavity.

In a preferred embodiment of this invention, a nanoporous scaffold lining is used inside the ablator capsule. The nanoporous scaffold wicks liquid hydrogen fuel (such as DT) and lowers the crystallization temperature of the DT. This lowers the hydrogen vapor density in the capsule gas-phase cavity and, hence, improves fusion capsule performance. Our analysis as shown in FIGS. 4 and 5 indicates that the crystallization temperature of hydrogen inside a nanoporous scaffold is reduced by up to about 30%, lowering the DT vapor density to an acceptable value even for the current NIF ignition target design.

A challenge of the fabrication of such liquid DT targets relates to the formation of low-density (less than about 50 mg/cc) nanofoam liners on the inner surface of a ICF fuel capsules. The nanofoam scaffold is intended to completely or partially suppress the crystallization of liquid hydrogen fuel to an acceptable temperature dictated by the maximum concentration of hydrogen in the capsule gas-phase cavity. The nanoporous scaffold also should withstand wetting with liquid hydrogen fuel and tritium beta-decay radiation. In our analysis to date, carbon aerogels, carbon-nanotube aerogels, graphene aerogels, and polymeric aerogels appear suitable. These materials are being developed at LLNL and other research centers.

In a preferred embodiment of this invention a fusion fuel capsule includes a substantially spherical ablator capsule with at least one doped layer on its interior. The dopant is an element heavier than the primary element of the ablator. A nanoporous scaffold layer is positioned inside the ablator, with a liquid DT mixture confined inside the pores of the nanoporous scaffold. Preferably the nanoporous scaffold layer has a density of about 50 mg/cc or lower.

### BRIEF DESCRIPTION OF THE DRAWINGS

FIG. 1 illustrates a prior art ICF fuel target assembly for hot-spot ignition experiments at the National Ignition Facility;

FIG. 2 shows ICF target designs for (a) hot-spot and (b) fast ignition approaches for fusion capsules;

FIG. 3 is a diagram illustrating layering geometry in indirect-drive hot-spot ignition targets currently used for experiments at the National Ignition Facility;

FIG. 4 illustrates the suppression of crystallization of hydrogen in nanoporous silica glass;

FIG. 5 illustrates the dependence of the equilibrium vapor pressure of DT on temperature; and

FIG. 6 illustrates a hohlraum and fuel capsule for fusion power plants.

### DETAILED DESCRIPTION OF THE INVENTION

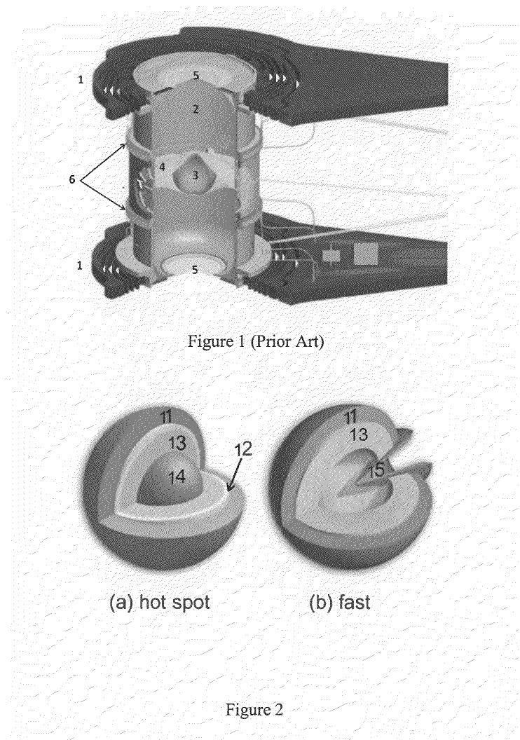

FIG. 1 illustrates a prior art ICF fuel target assembly for hot-spot ignition experiments at the National Ignition Facility. The components illustrated include cryocooling single-crystal silicon arms 1 connected to the cold finger of a cryostat and a gold hohlraum 2. A fuel capsule 3 having a beryllium metal, carbon, or plastic ablator shell with an outer diameter of about 2 mm is positioned in the center of the hohlraum 2. It is supported there by about 10-100-nm-thick polymer “tents” 4, which center and hold the ablator shell in the hohlraum 2. Laser entrance holes 5 at each end of the hohlraum 2 are sealed with about 500-nm-thick polymer films. Heaters 6 control the growth and uniformity of the solid hydrogen (DT) fuel layer (not shown) inside of the ablator shell of the capsule 3. In the NIF experiments, laser beams enter the hohlraum through the laser entrance holes 5, irradiating the interior of the hohlraum 2. X-rays from the hohlraum 5 then strike the fuel capsule 3 and compress it, causing the fusion reaction of the DT fuel therein.

FIG. 2 illustrates ICF target designs according to preferred embodiments of this invention for (a) hot-spot, and (b) fast ignition approaches to fusion. In both FIGS. 2(a) and 2(b) the fuel capsule 10 includes a low-Z ablator 11, a low-Z nanoporous scaffold 13 impregnated with fuel in a condensed phase, and fuel 14 in the gas phase. In the fast ignition capsule of FIG. 2(b) a reentrant cone 15 is illustrated. In some embodiments of the invention a portion 12 of the ablator shell 11 is doped with elements heavier than those comprising the ablator shell, for example, silicon. The doped layer 12 is not necessarily confined to the inner surface of the ablator shell, and the thickness of the doped layer 12 is preferably determined by target performance optimization. While this optional dopant layer 12 is illustrated only in FIG. 2(a), it could be used in the embodiment of FIG. 2(b).

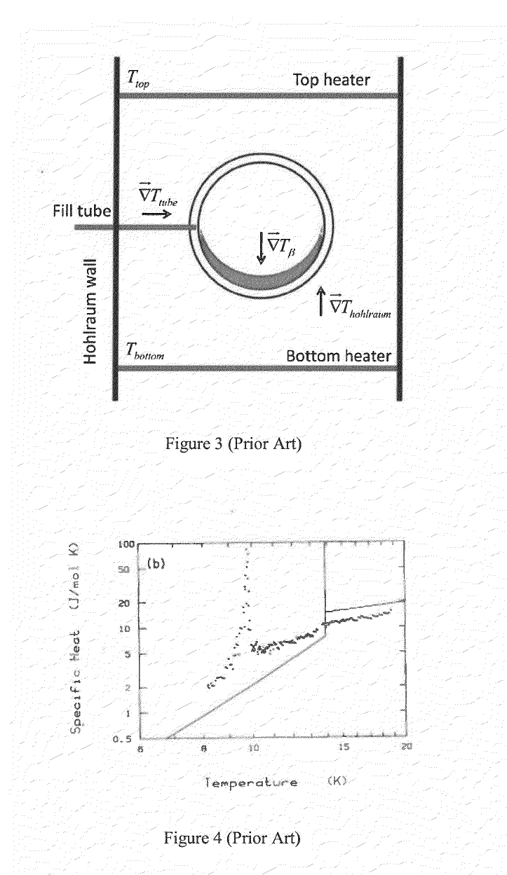

FIG. 3 is a schematic illustrating layering geometry in indirect-drive hot-spot ignition capsules currently pursued for experiments at the National Ignition Facility. The three main thermal gradients illustrated are imposed by the top and bottom hohlraum heaters, the fill tube, and the DT layer itself (due to tritium-beta-decay-induced heating).

FIG. 4 illustrates the suppression of crystallization of hydrogen in nanoporous silica glass (with about 3 nm pores) by 4 K, corresponding to about 29% of the bulk freezing temperature. This figure and data are taken from J. L. Tell and H. J. Maris, Phys. Rev., B 28, 5122 (1983).

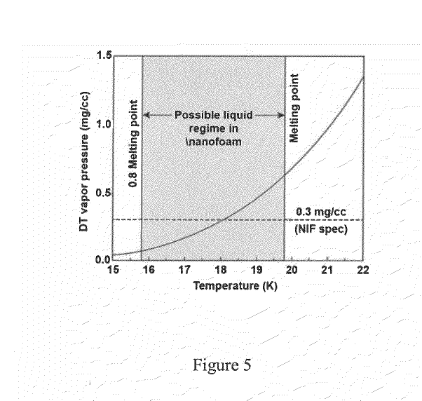

FIG. 5 illustrates the dependence of the equilibrium vapor pressure of DT on temperature. These DT vapor pressure data are taken from P. C. Souers, Hydrogen Properties for Fusion Energy, University of California Press, Berkeley, 1986. Note that the liquid regime in a nanofoam extends between about 16 K and 20 K. The NIF specification of 0.3 mg/cc is shown as a dashed line in the figure.

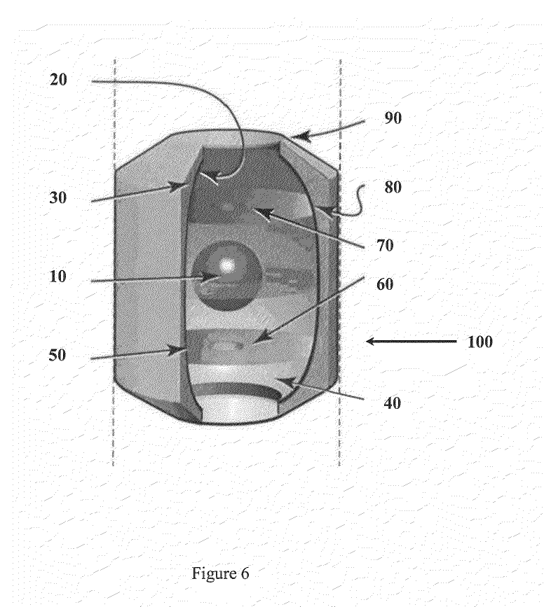

FIG. 6 illustrates a typical fusion target design that could be employed in a fusion power plant. The general structure of this target and its method of manufacture are described in our commonly assigned co-pending PCT patent application entitled: “Indirect Drive Targets for Fusion Power,” PCT/US2011/059634 and WO 2012/064668, filed Nov. 7, 2011, the contents of which are incorporated by reference herein. The invention described herein relates to the fuel capsule 10.

In the embodiment illustrated in FIG. 6, the fuel capsule 10 containing the fusion fuel is about a 2 mm radius hollow spherical capsule made of low Z elements such as fluorine, nitrogen, oxygen, carbon, boron, beryllium, or hydrogen. In a preferred embodiment, the capsule has a wall thickness of about 100 μm, and the inner deuterium-tritium (DT) fuel layer is about 150 82 m thick. At the time of use, the capsule and hohlraum have been cooled to a temperature on the order of less than 20 K.

In the implementation depicted in FIG. 6, the hohlraum 100 is made generally of lead, about 1 cm in diameter by about 2 cm long, with an insulating wall 30. Laser entrance openings 90 at each end of the hohlraum (the top and bottom in the illustration) allow entrance of the laser beams into the interior of the hohlraum where they strike the inner surface. An approximately 20 μm thick layer of high-Z material 20, e.g., plated lead, on the inside hohlraum wall provides for more efficient x-ray production in response to the laser beams. The hohlraum has a rugby ball-shaped interior 80 for better coupling of the expected approximately 2.2 megajoule (MJ) laser energy to the fuel capsule 10. The shape of the interior surface is a circular arc with origin vertically offset to satisfy the prescribed dimensions of the hohlraum, e.g., maximum and minimum inner radii, and length.

Infrared reflectors 50, typically formed from a low-Z membrane material such as carbon or polyimide coated with a thin reflective metal layer such as about 30 nm thick aluminum, help protect the capsule from radiant heat in the fusion chamber. “P2” shields 60 and 70, typically manufactured from the same material as the hohlraum, and deposited onto the polyimide membrane 50, provide symmetry and enhancement of the x-ray bath around the capsule 10. An additional low-Z membrane midway between the shields is used to support the capsule 10 within the hohlraum 100. The hohlraum is filled with helium gas 40 which tamps the degree of the hohlraum wall expansion to provide greater symmetry control. The gas is sealed in by the windows 90 over the laser entrance holes at opposite ends of the hohlraum. The exterior surface of the hohlraum 100 has cylindrical sides to enable guidance by a target injector used to introduce the targets into the fusion chamber.

For high repetition-rate target injection in proposed ICF fusion power plant applications, capsules containing liquid DT supported by a low-density (about 50 mg/cm3 or lower) nanoporous scaffold liner appear particularly promising. Because the capillary pressure is inversely proportional to the pore radius, foams with small pores are needed. The pore size of the foam liner, however, is defined not only by the capillary pressure required to compensate for gravitational sagging force, but also by a requirement that pore and ligament sizes be in the submicron range to limit the growth of hydrodynamic instabilities during the implosion. Such a nanoporous liner should also have densities significantly below the density of the hydrogen fuel (about 200 mg/cc for DT). Furthermore, such a nanofoam should have mechanical properties sufficient to withstand meniscus forces of liquid hydrogen and radiation-stability to survive beta-decay radiation of liquid tritium-containing fuels.

One method of fabrication of such nanoporous liners is the known sol-gel approach and its variants. The resultant nanoporous materials are often referred to as aerogels. Aerogel is a synthetic porous material derived from a gel, in which the liquid component of the gel is replaced with a gas. The result is a solid with extremely low density, for example, down to about 1 mg/cc.

One of the advantages of using a nanoporous scaffold as described here is that the porous structure lowers the melting point of liquid DT, enabling its vapor density to be reduced below the DT vapor density at the freezing point of unconfined DT. The lower DT vapor density improves the ICF capsule performance during the implosion.

It is important for the fusion implosion that the DT layer thickness be uniform. To achieve this we use liquid DT layers in a nanoporous scaffold used to wick in liquid DT to form the layer. DT layer uniformity depends on its mechanical properties. The strain caused by mechanical stresses that layers experience during acceleration into the chamber center is one source of layer non-uniformity. An advantage of our design is that the nanoporous scaffold and the liquid DT appear to be less susceptible to damage from the acceleration applied to them, than do solid DT layers. The hydrogen liquid filled nanoporous scaffold could also aid in damping mechanical oscillations launched by the target injection process.

The use of liquid DT confined in a nanoporous liner can also reduce the fill time compared to the methods currently used to fill NIF fuel capsules. Filling could, for example, be performed via wicking of the hydrogen into the nanoporous scaffold via material transport through the gas or liquid phase. Because of the need for large numbers of fuel capsules, reduced fill time is important. It also enables reduction of the tritium inventory.

The nanoporous scaffold method described here has additional advantages for fast-ignition targets such as illustrated in FIG. 2(b). Indeed, achieving spherical isotherms, necessary for radial thermal gradient methods to work in the presence of a symmetry breaking cone does not appear to be feasible. The formation of a uniform fuel layer on the capsule wall, and not on the surface of the metal cone of a fast ignition target, could be achieved by confining the fuel inside a low-density nanoporous scaffold.

The nanoporous scaffold, however, has both positive and negative impacts on capsule performance. An example of an optimized fuel capsule configuration for a target with a nanoporous scaffold that enables improved fusion engine performance has been discussed by D. D. Ho, et al. in “Ignition Capsules with Aerogel-Supported Liquid DT Fuel for the National Ignition Facility,” Nov. 2, 2011, LLNL-PROC-510251, a copy of which is included with the provisional patent application referenced above.

One of the disadvantages of use of the aerogel is that for the same fuel mass, the payload mass for a capsule with a nanoporous scaffold is increased. The increased payload mass reduces the peak velocity and therefore the robustness of the fusion reaction. Furthermore, assuming the outer radius of the fuel layer remains the same as that of the pure DT NIF capsule, because liquid DT has lower density (0.225 g/cm3), the fuel layer is thicker for the same fuel mass. This also reduces the peak velocity of implosion. A third disadvantage is that carbon or similar mass atoms in the scaffold absorb radiation and raise the fuel entropy. These disadvantages could potentially be overcome by target design optimization, as described by Ho and co-workers, who presented a systematic method for optimizing the robustness and yield for capsules with wetted aerogels.

The preceding has been a description of the preferred embodiments of this invention. It should be appreciated that numerous details have been provided to enable a more complete understanding of the invention. The scope of the invention, however, is set forth in the appended claims.

What is claimed is:

1. A fusion fuel capsule comprising:
a substantially spherical ablator shell having an inner surface and an outer surface;
a nanoporous scaffold layer disposed on the inner surface; and
a liquid mixture of deuterium and tritium disposed in the nanoporous scaffold layer.

2. A fusion fuel capsule as in claim 1 wherein the nanoporous scaffold layer has a density not greater than about 50 mg/cm³.

3. A fusion fuel capsule as in claim 1 wherein the substantially spherical ablator shell has a radius of about 1 mm.

4. A fusion fuel capsule as in claim 1 wherein the substantially spherical ablator shell has a thickness of about 200 μm.

5. A fusion fuel capsule as in claim 6 wherein the nanoporous scaffold layer is about 100 μm thick.

6. A fusion fuel capsule as in claim 1 wherein the ablator comprises at least one of fluorine, nitrogen, oxygen, carbon, boron, beryllium, or hydrogen.

7. A fusion fuel capsule as in claim 6 wherein a part of the ablator shell is doped with elements heavier than those comprising the ablator shell.

8. A fusion fuel capsule as in claim 1 further comprising a fast ignition cone extending through the ablator shell from the outer surface to the inner surface.

9. A fusion fuel capsule as in claim 1 disposed in a hohlraum.

10. A fusion fuel capsule as in claim 9 wherein the hohlraum comprises a cylindrical structure having laser entrance openings at opposite ends thereof with the fuel capsule supported along a central axis of the cylindrical structure.

11. A fusion fuel capsule as in claim 10 wherein the hohlraum further comprises a pair of infrared reflectors disposed on opposite sides of the fuel capsule.

12. A fusion fuel capsule as in claim 11 wherein the hohlraum further comprises a membrane midway between the infrared reflectors to support the fuel capsule within the hohlraum.

13. A fusion fuel capsule as in claim 1 wherein the ablator shell has a wall thickness of about 100 μm and the liquid mixture of deuterium and tritium disposed in the nanoporous scaffold layer is about 150 μm thick.

14. A method of making a fuel capsule for a fusion engine comprising:
providing a substantially spherical ablator shell;
forming a layer of a nanoporous scaffold on the inner surface of the ablator shell; and
introducing a liquid mixture of deuterium and tritium into the nanoporous scaffold.

15. A method as in claim 14 wherein the step of forming a layer of a nanoporous scaffold on the inner surface of the ablator shell comprises forming an aerogel on the inner surface of the ablator shell.

16. A method as in claim 14 wherein the step of introducing a liquid mixture of deuterium and tritium into the nanoporous scaffold comprises wicking the liquid mixture into the nanoporous scaffold.
